(19) United States
(12) Patent Application Publication
(10) Pub. No.: US 2014/0066018 A1
(43) Pub. Date: Mar. 6, 2014

(54) Location Based Privacy for Proximity Services

(71) Applicant: TeleCommunication Systems, Inc., Annapolis, MD (US)

(72) Inventor: Yinjun Zhu, Sammamish, WA (US)

(73) Assignee: TeleCommunication Systems, Inc., Annapolis, MD (US)

(21) Appl. No.: 14/017,846

(22) Filed: Sep. 4, 2013

Related U.S. Application Data
(60) Provisional application No. 61/697,612, filed on Sep. 6, 2012.

(51) Int. Cl. H04W 12/02

(52) U.S. Cl. CPC H04W 12/02
USPC 455/411

(57) ABSTRACT

Location based privacy settings for proximity based services that enable an end-user to define one or more geographic areas, and then explicitly opt in or opt out to proximity based services per geographic area. Location based privacy settings can be stored and managed at a network level or stored and managed locally. In the network-centric solution, privacy settings for proximity based services are defined via a subscriber privacy register. In the mobile-centric solution, privacy settings for proximity based services are defined via a user interface on a proximity services enabled device. When a proximity services enabled device receives a request for proximity based services (i.e. a peer discovery signal command for device discovery or a peer-to-peer communications request for direct communications), the device checks the current date/time and a serving network identifier/current location against location based privacy settings to determine if proximity based services are allowed on the device.

The present invention claims priority from U.S. Provisional No. 61/697,612, filed Sep. 6, 2012, entitled “Location Based Privacy for Proximity Based Services”, the entirety of which is expressly incorporated herein by reference.

### BACKGROUND OF THE INVENTION

1. Field of the Invention

This invention relates generally to wireless Internet Service Providers, Public Safety Service Providers and information content delivery services/providers for wireless networks and/or Public Safety Service networks. More particularly, it relates to location services for the wireless industry.

2. Background of Related Art

A conventional proximity based service is a service that utilizes location technology to enable subscriber devices to discover other subscriber devices located within a predefined proximity range. Proximity based service enabled devices that discover one another can then engage in direct peer-to-peer (p2p) communications, with or without use of a base station. WiFi may also be used as a medium for proximity based services.

In accordance with conventional technology, a proximity based service is comprised of two distinct components: device discovery and direct communications.

The device discovery component of a proximity based service leverages a CDMA radio (or WiFi radio, etc.) (when subscriber devices are being serviced by a network that supports proximity based services) to enable subscriber devices to discover other subscriber devices that are located nearby (i.e. within a predefined proximity).

FIG. 7 depicts a conventional method of device discovery for proximity based services.

In particular, as depicted in step 72 of FIG. 7, a device transmits a discovery request to initiate device discovery for proximity based services. As depicted in step 74, base stations located within a predefined proximity of the requesting device receive the discovery request and broadcast a command for peer discovery signal transmission. As portrayed in step 76, proximity service enabled devices receiving coverage from the one or more base stations located within a predefined proximity to the requesting device, receive the command for peer discovery signal transmission and transmit a peer discovery signal for radio frequency (RF) proximity discovery (i.e. neighbor discovery). As shown in step 78, the requesting device monitors the pilot channels of base stations located within the predefined proximity zone, to determine if any proximity service enabled devices are located nearby.

In accordance with conventional technology, the direct communications component of a proximity based service permits any two or more proximity service enabled devices that are located within a predefined proximity of one another, to engage in direct peer-to-peer (p2p) communications.

FIG. 8 depicts an illustrative example of direct communications for proximity based services.

In particular, as depicted in FIG. 8, when two or more proximity service enabled devices 800, 810, 820 discover one another within a predefined proximity zone 830, the devices 800, 810, 820 can set up a direct peer-to-peer (p2p) communications session 840 with or without use of a radio network infrastructure (e.g. a base station) 850.

Conventional proximity based services yield a number of potential applications, e.g., friend finding, gaming, etc. A common example of a conventional proximity based service is geofencing (aka area event triggered or area watching). A geofencing service is a service that generates an event based notification each time a target mobile device enters or exits a predefined geographic area.

Unfortunately, many users are hesitant to deploy proximity based services because privacy options for proximity based services are quite limited. In particular, privacy options for conventional proximity based services are generally limited to: proximity based services always on and proximity based services always off. However, users desire privacy options that permit greater flexibility and control over the deployment of proximity based services.

For instance, users may desire the option to enable/disable proximity based services based on device location. For example, a user that makes frequent business trips to Denver, Colo., may want the option to dynamically disable peer-to-peer (p2p) communications for proximity based services, whenever a device is located in or near Denver, Colo., so as to minimize potential work distractions. Unfortunately, conventional proximity based services do not provide location based privacy options.

Today, privacy is of top concern to technology users. Thus, additional privacy options for proximity based services are needed.

### SUMMARY

Methods and apparatus for providing location based privacy for proximity based services comprises a network-centric solution and a mobile-centric solution. In the network-centric solution, location based privacy settings for proximity based services are stored and managed at a network level. Moreover, in the mobile-centric solution, location based privacy settings for proximity based services are stored and managed locally on a proximity services enabled device.

In accordance with the principles of the present invention, a network-centric solution for providing location based privacy for proximity based services (i.e. device discovery and peer-to-peer (p2p) communications) comprises a subscriber privacy register. A subscriber privacy register allows end-users to define location based privacy settings for proximity based services. In particular, a subscriber privacy register allows a user on a proximity services enabled device to define one or more geographic areas, and then explicitly opt in or opt out to proximity based services (i.e. device discovery and/or peer-to-peer (p2p) communications) per geographic area. A home location server on a serving wireless network preferably converts a set of geographic areas defined in location based privacy settings for proximity based services to a set of corresponding network identifiers.

In accordance with the principles of the present invention, a network-centric solution for providing location based privacy for proximity based services also comprises a proximity service register. A proximity service register maintains subscriber data for proximity based services. Moreover, during network registration, the proximity service register retrieves privacy settings defined for a registering proximity services enabled device, and forwards the privacy settings to the device. Privacy settings preferably include network identifiers that have been converted from geographic areas defined by an end-user.

In accordance with the principles of the present invention, each instance a request for proximity based services (e.g. a command for peer discovery signal transmission or a peer-to-peer (p2p) communications request) is received on a proximity services enabled device in the inventive network-centric solution, the device checks the current date and time and a serving network identifier against location based privacy settings to determine if proximity based services (i.e. device discovery and/or peer-to-peer (p2p) communications) are permitted on the device.

In the inventive mobile-centric solution for providing location based privacy for proximity based services, an end-user provisions location based privacy settings for proximity based services via a user interface on a proximity services enabled device. Like the network-centric solution, the mobile-centric solution allows an end-user to define one or more geographic areas, and then explicitly opt in or opt out to proximity based services (i.e. device discovery and/or peer-to-peer (p2p) communications) per geographic area.

In accordance with the principles of the present invention, when location based privacy settings for proximity based services are stored and managed on a proximity based services enabled device, the device must check its own location (via a mobile originated positioning procedure) against location based privacy settings, each instance a command for proximity based services (e.g. a command for peer discovery signal transmission or a peer-to-peer (p2p) communications request) is received thereon. The device uses privacy settings to determine if device discovery and/or peer-to-peer (p2p) communications for proximity based services is allowed on the device, and then responds to each request accordingly.

### BRIEF DESCRIPTION OF THE DRAWINGS

Features and advantages of the present invention will become apparent to those skilled in the art from the following description with reference to the drawings, in which:

FIG. 1 depicts an exemplary network structure for providing a network-centric location based privacy solution for proximity based services, in accordance with the principles of the present invention.

FIG. 2 depicts an exemplary network-centric solution for providing location based privacy for proximity based services, in accordance with the principles of the present invention.

FIG. 3 depicts an exemplary process flow for proximity based services performed in a geographic area wherein devices have no privacy settings defined for proximity based services, in accordance with the principles of the present invention.

FIG. 4 depicts an exemplary process flow for proximity based services performed in a geographic area wherein a device is not discoverable, in accordance with the principles of the present invention.

FIG. 5 depicts an exemplary process flow for proximity based services performed in a geographic area wherein a device is discoverable with peer-to-peer communications not allowed, in accordance with the principles of the present invention.

FIG. 6 depicts an exemplary mobile-centric solution for providing location based privacy for proximity based services, in accordance with the principles of the present invention.

FIG. 7 depicts a conventional method of device discovery for proximity based services.

FIG. 8 depicts an illustrative example of direct communications for proximity based services.

### DETAILED DESCRIPTION OF ILLUSTRATIVE EMBODIMENTS

The present invention provides methods and apparatus for providing location based privacy for proximity based services.

A conventional proximity based service is a service that utilizes location technology to enable subscriber devices to discover other subscriber devices located within a predefined proximity zone (i.e. device discovery). Devices that discover one another may then engage in direct peer-to-peer (p2p) communications, with or without use of an intermediary radio network infrastructure (e.g. a base station).

Conventional proximity based services yield numerous potentials applications, e.g., friend finding, gaming, geofencing, etc. However, privacy options for proximity based services are quite limited. In particular, privacy options for proximity based services conventionally comprise one option: to enable or disable proximity based services on a proximity services enabled device.

In accordance with the principles of the present invention, location based privacy options for proximity based services provide users with increased flexibility and control over the deployment of proximity based services. In particular, location based privacy options for proximity based services permit an end-user to enable/disable proximity based services based on device location.

More particularly, inventive location based privacy options for proximity based services enable an end-user to define a specific geographic area, and then explicitly allow or disallow (or allow only upon user consent) proximity based services (i.e. device discovery and/or peer-to-peer (p2p) communications) on a device, when the device is located in that geographic area.

In accordance with the principles of the present invention, a geographic area defined in privacy settings for proximity based services is assigned one of the following privacy settings: not discoverable, discovery allowed and peer-to-peer (p2p) communications not allowed, discovery allowed and peer-to-peer (p2p) communications allowed only upon user consent, discovery allowed only upon user consent and peer-to-peer (p2p) communications allowed only upon user consent, or discovery allowed and peer-to-peer (p2p) communications allowed. In accordance with the principles of the present invention, location based privacy settings for proximity based services are defined by an end-user.

The present invention comprises a network-centric solution and a mobile-centric solution for providing location based privacy for proximity based services. In the network-centric solution, location based privacy settings for proximity based services are stored and managed at a network level. Moreover, in the mobile-centric solution, location based privacy settings for proximity based services are stored and managed locally.

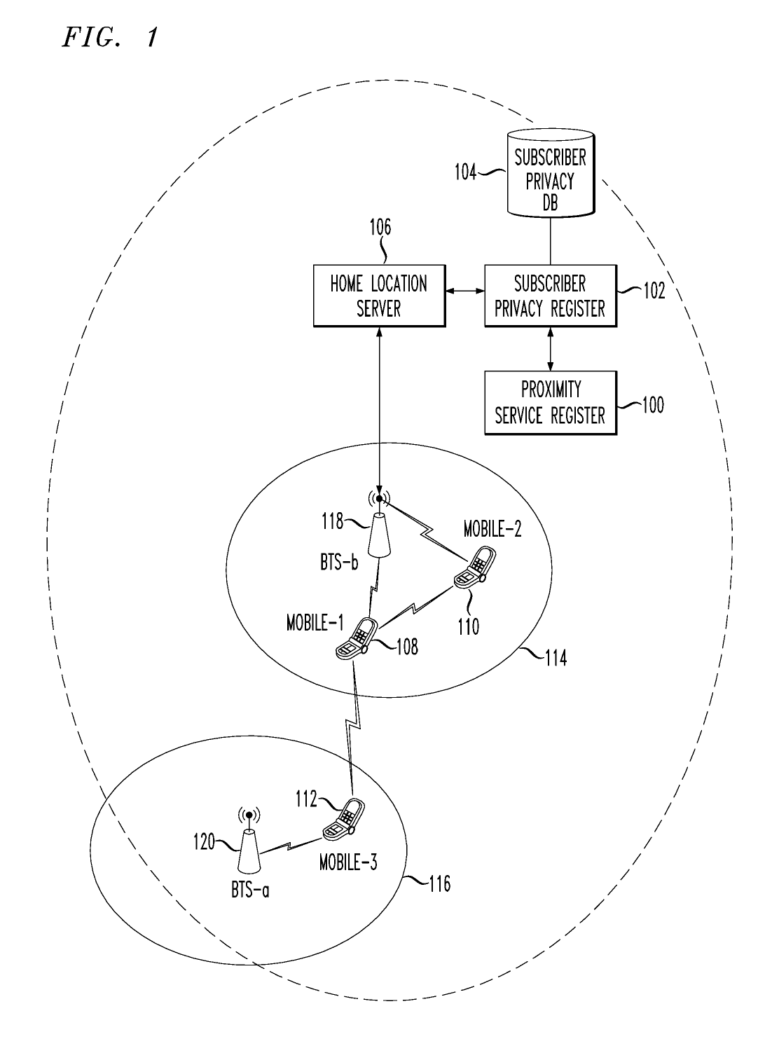

FIG. 1 depicts an exemplary network structure for providing a network-centric location based privacy solution for proximity based services, in accordance with the principles of the present invention.

In particular, as depicted in FIG. 1, a network centric-solution (i.e. a solution wherein privacy settings for proximity based services are stored and managed at a network level) for providing location based privacy for proximity based services comprises a proximity service register 100. In accordance with the principles of the present invention, a proximity service register 100 manages subscriber data for proximity based services. More particularly, a proximity service register 100 maintains subscriptions to proximity based services, subscriber device relationships (e.g. subscriber devices current proximity to one another, subscriber devices currently engaged in peer to peer (P2P) communications, etc.), groups of subscribers (e.g. subscribers grouped by organization), and associated service identifiers (i.e. unique proximity based service identifiers).

Moreover, as portrayed in FIG. 1, the present invention additionally utilizes a subscriber privacy register 102. In accordance with the principles of the present invention, a subscriber privacy register 100 enables a user of a proximity services enabled device to define privacy settings for proximity based services. Privacy settings are stored in a subscriber privacy database 104 on the subscriber privacy register 102.

When a proximity services enabled device registers with a network, a proximity service register 100 on that network queries the subscriber privacy register 102 to retrieve privacy settings maintained for the device. The proximity service register 100 then forwards retrieved privacy settings to the proximity services enabled device (unless privacy settings have already been synched thereto). If privacy settings previously synched to a device have been updated, the proximity service register 100 forwards only the updated privacy settings to the device.

As depicted in FIG. 1, a home location server 106 on a serving wireless network retrieves location information for a proximity services enabled device. A location of a proximity services enabled device is used to validate location based privacy settings defined therefore. The home location server 106 also preferably converts geographic areas defined in a set of location based privacy settings to a set of corresponding network identifiers.

Conventional device discovery for proximity based services is achieved via several different methods, e.g., a proximity services enabled device periodically transmits a peer discovery signal for RF proximity discovery (i.e. neighbor discovery), etc. In accordance with the principles of the present invention, inventive location based privacy restrictions for proximity based services may be used in combination with any conventional method of device discovery. However, for purposes of detailing the present invention, examples depicted herein are based on a network-controlled device discovery method.

In a conventional network-controlled device discovery method, a device transmits a peer discovery signal in response to a command for peer discovery signal transmission, initiated by a serving wireless network for a proximity based service (identified by a service ID) to which the device is subscribed.

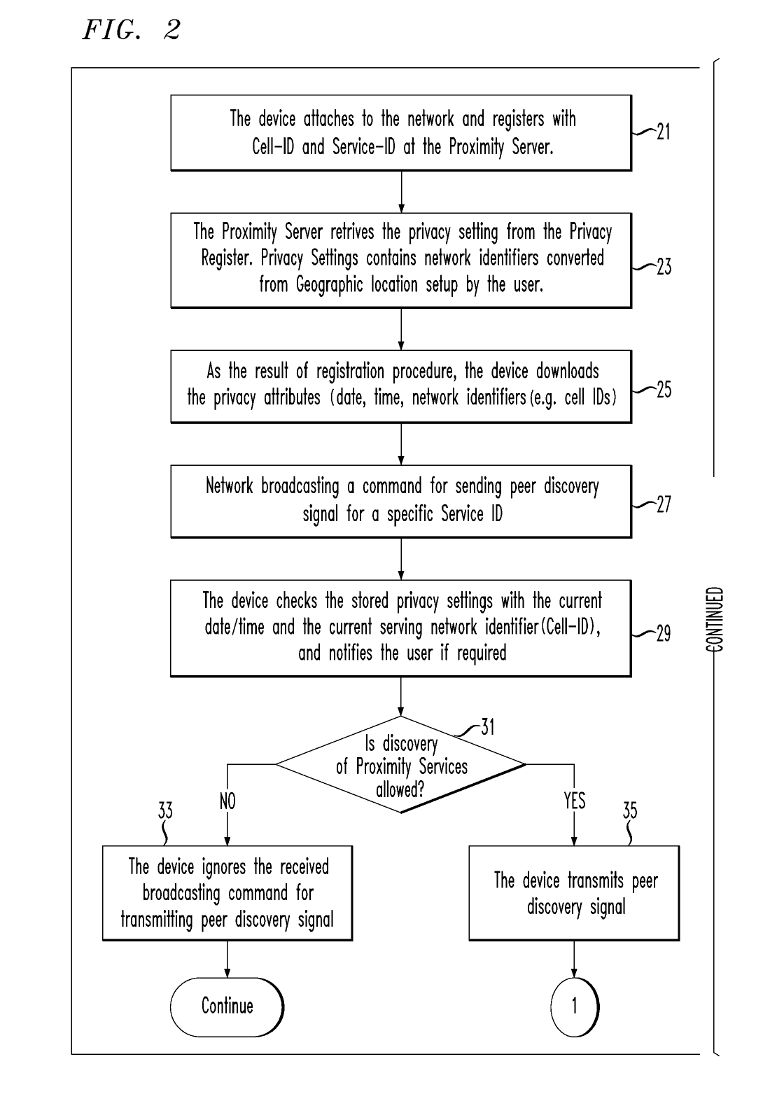

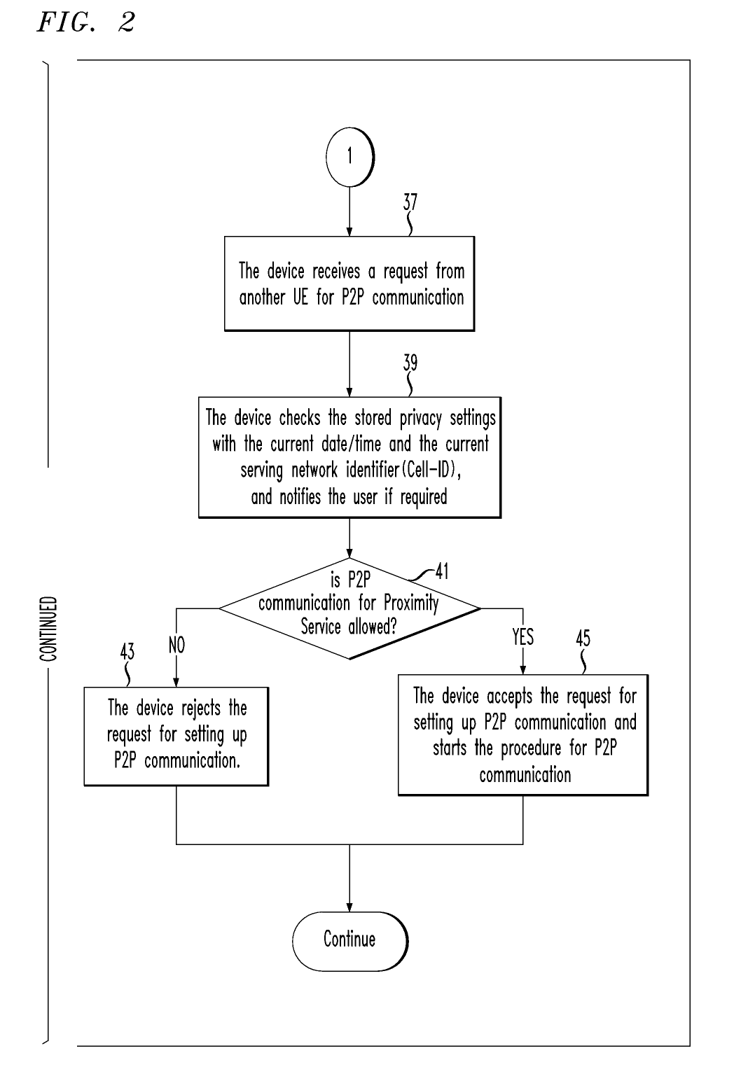

FIG. 2 depicts an exemplary network-centric solution for providing location based privacy for proximity based services, in accordance with the principles of the present invention.

In particular, as depicted in step 21 of FIG. 2, a mobile device attaches to a network and registers via cell-ID and service-ID (i.e. a proximity based service identifier) at an inventive proximity service register 100. As depicted in step 23, the proximity service register 100 retrieves privacy settings for proximity based services defined for the mobile device from a subscriber privacy register 102. Location based privacy settings preferably include network identifiers that have been converted (via a home location register) from geographic areas defined by an end-user. Following network registration, the proximity service register 100 synchs user-defined privacy settings (e.g. date, time, network identifiers, etc.) to the mobile device, as depicted in step 25. In step 27, the network broadcasts a peer discovery signal transmission command for a proximity based service (identified by service ID) to which the device is subscribed. Upon receiving the network command, the device checks privacy settings downloaded on the device, against the current date/time, and against a serving network identifier (i.e. cell ID), and sends a request for user consent to the end-user, if required (step 29). As portrayed in step 31, if device discovery for proximity based services is not permitted on the device (i.e. privacy settings disallow device discovery or user consent is not provided for device discovery), then the device ignores the network command for peer discovery signal transmission and does not transmit a peer discovery signal (step 33). Alternatively, if device discovery for proximity based services is permitted on the device (i.e. privacy settings allow device discovery and/or user consent is provided for device discovery) (step 31), then the device responds to the received network command by transmitting a peer discovery signal, as depicted in step 35.

In step 37, the device receives a peer-to-peer (p2p) communications request from another subscriber device. Upon receipt, the device checks privacy settings downloaded on the device against the current date/time, and against a serving network identifier (i.e. cell ID), and sends a request for user consent to the end-user, if required (step 39). As shown in step 41, if peer-to-peer (p2p) communications for proximity based services is not allowed on the device (i.e. privacy settings disallow peer-to-peer (p2p) communications or user consent is not provided for peer-to-peer (p2p) communications), then the device rejects the request for peer-to-peer (p2p) communications (step 43). Alternatively, if peer-to-peer (p2p) communications for proximity based services is allowed on the device (i.e. privacy settings allow peer-to-peer (p2p) communications and/or user consent is provided for peer-to-peer (p2p) communications) (step 41), then the device accepts the request for peer-to-peer (p2p) communications, and a peer-to-peer (p2p) communications session is subsequently established, as portrayed in step 45.

The following use cases provide an overview of how location based privacy can be invoked for proximity based services. The following use cases are based on a network-controlled device discovery procedure (although various conventional methods of device discovery may be used) and refer to exemplary mobile devices 108, 110, 112 depicted in FIG. 1.

In particular, use case one is a network-centric solution wherein no privacy settings are defined for proximity based services. In accordance with the principles of the present invention, devices with no privacy settings defined for proximity based services are considered discoverable, with peer-to-peer (p2p) communications allowed.

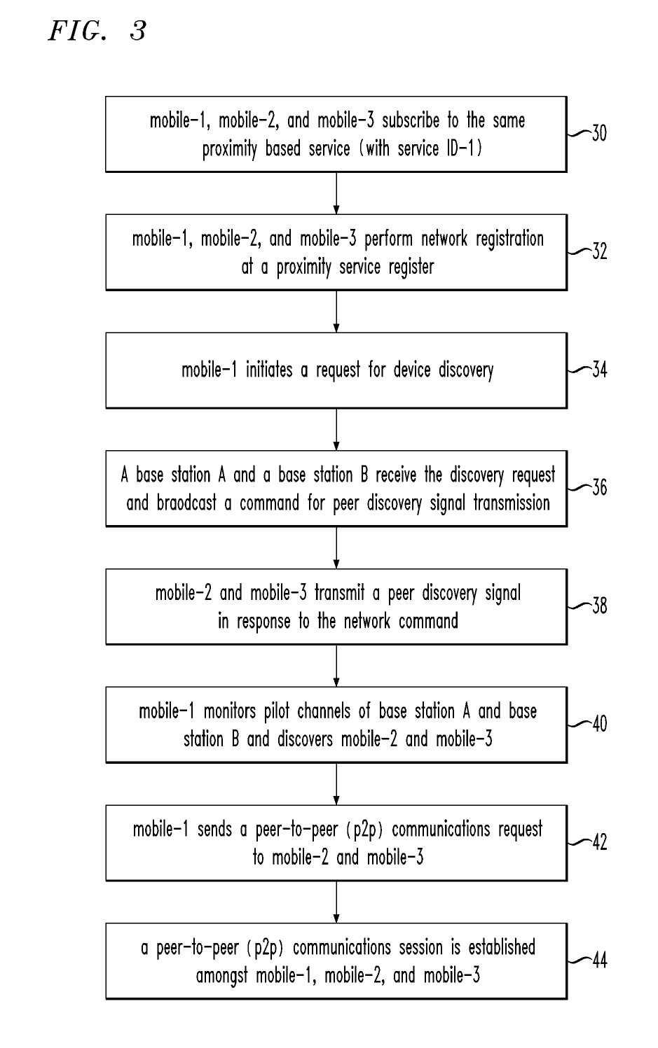

FIG. 3 depicts an exemplary process flow for proximity based services performed in a geographic area wherein devices have no privacy settings defined for proximity based services, in accordance with the principles of the present invention.

In particular, as depicted in step 30 of FIG. 3 (use case one), proximity service enabled devices: mobile-1 108, mobile-2 110, and mobile-3 112, all subscribe to the same proximity based service (with proximity service ID-1).

As shown in step 32, mobile-1 108, mobile-2 110, and mobile-3 112 move in to the coverage areas 114 and 116 of a base station B (BTS-B) 118 and a base station A (BTS-A) 120, respectively, and are all registered by mobile identifier and cell-ID at an inventive proximity service register 100.

In step 34, mobile-1 108 initiates a request for device (service-ID1) discovery. As depicted in step 36, base station B (BTS-B) 118 and base station A (BTS-A) 120, both of which are located within a predefined proximity 122 of mobile-1 108, broadcast a peer discovery signal transmission command (with service ID-1) within their respective cells 114 and 116, in response to the discovery request.

As depicted in step 38, mobile-2 110, and mobile-3 112 each transmit a peer discovery signal in response to the network command.

As shown in step 40, mobile-1 108 monitors the pilot channels of BTS-B 118 and neighbor cell, BTS-A 120, and measures the radio properties (e.g. signal strength and/or timing etc) of the peer discovery signal to determine if any mobile devices are located within a predefined proximity zone 122. Mobile-2 110 and mobile-3 112 are within proximity.

In step 42, mobile-1 108 sends a peer-to-peer (P2P) communications request to mobile-2 110 and mobile-3 112.

As shown in step 44, a peer-to-peer (P2P) communications session is established between mobile-1 108, mobile-2 110, and mobile-3 112.

Use case 2 is a network-centric solution wherein a device defines location based privacy settings for proximity based services as: not discoverable.

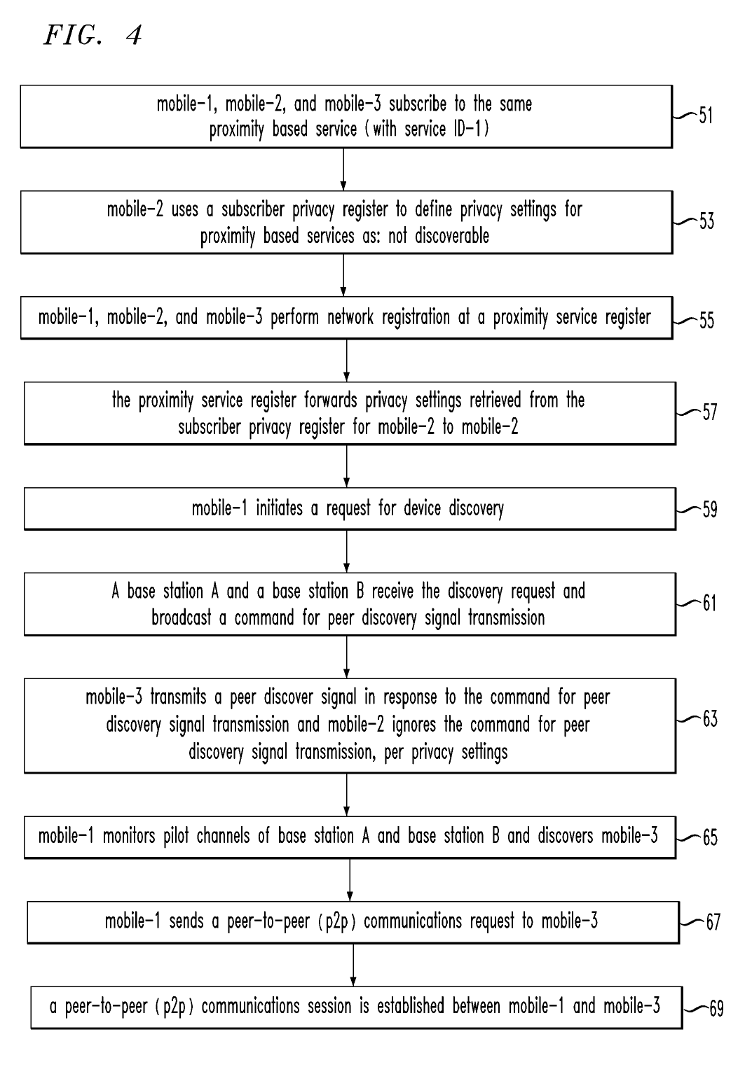

FIG. 4 depicts an exemplary process flow for proximity based services performed in a geographic area wherein a device is not discoverable, in accordance with the principles of the present invention.

In particular, as shown in step 51 of FIG. 4 (use case 2), mobile-1 108, mobile-2 110, and mobile-3 112 all subscribe to the same proximity service (with proximity service ID-1).

In step 53, users of mobile-1 108 and mobile-3 112 do not define privacy settings, whereas the user of mobile-2 110 uses an inventive subscriber privacy register 102 to define privacy settings for proximity based services as: not discoverable (or discoverable only upon user consent).

In step 55, mobile-1 108, mobile-2 110, and mobile-3 112 move in to the coverage areas 114 and 116 of a base station B (BTS-B) 118 and a base station A (BTS-A) 120, respectively, and are all registered by mobile identifier and cell-ID at an inventive proximity service register 100.

As shown in step 57, during network registration, the proximity service register 100 retrieves privacy settings defined for mobile-2 110 and forwards the privacy settings to the device 110. Privacy settings may consist of date, time, and a set of network identifiers that have been converted (preferably by a home location register) from one or more geographic areas defined in privacy settings provisioned for mobile-2 110.

In step 59, mobile-1 108 initiates a request for device discovery.

As shown in step 61, in response to the discovery request, base station B (BTS-B) 118 and base station A (BTS-A) 120, both of which are located within a predefined proximity 122 of mobile-1 108, broadcast a command for peer discovery signal transmission (with service ID-1) within their respective cells 114 and 116.

In step 63, mobile-3 112 transmits a peer discovery signal in response to the network command. However, mobile-2 110 identifies that cell A 120 and cell B 118 are each regarded as restricted areas, per location based privacy settings. Consequently, mobile-2 110 ignores the network command and does not transmit a peer discovery signal. Alternatively, if privacy settings defined for mobile-2 110 allow device discovery upon user consent, then mobile-2 110 sends a request for user consent to an end-user, upon receiving a network command for peer discovery signal transmission. For exemplary purposes, mobile-2 110 does not receive user consent for device discovery and mobile-2 110, thus, does not transmit a peer discovery signal.

As portrayed in step 65, mobile-1 108 monitors the pilot channels of BTS-B 118 and neighbor cell, BTS-A 120, and measures the radio properties (e.g. signal strength and/or timing etc) of the peer discovery signal to determine if any mobile devices are located within a predefined proximity zone 122. Mobile-3 112 is in proximity.

As depicted in step 67, mobile-1 108 sends a peer-to-peer (p2p) communications request to mobile-3 112.

In step 69, a peer-to-peer (p2p) communications session is established between mobile-1 108 and mobile-3 112.

Use case 3 is a network-centric solution wherein a device defines location based privacy settings for proximity based services as: discovery allowed and peer-to-peer (p2p) communications not allowed.

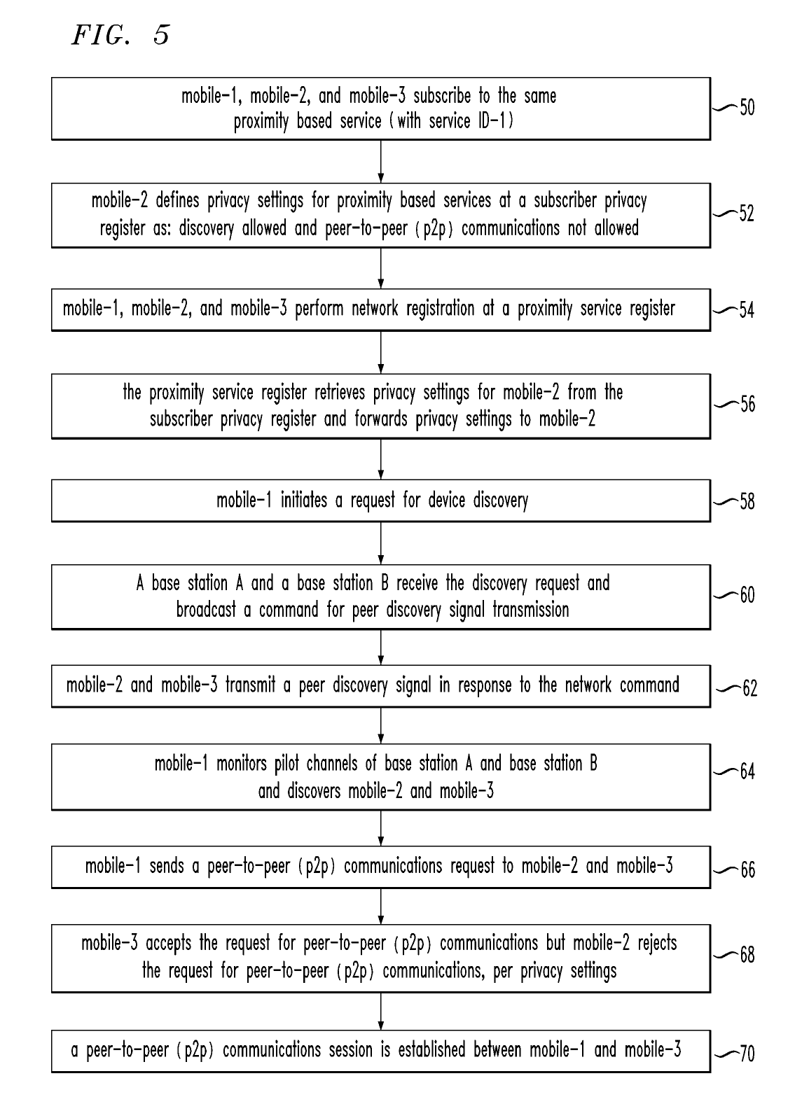

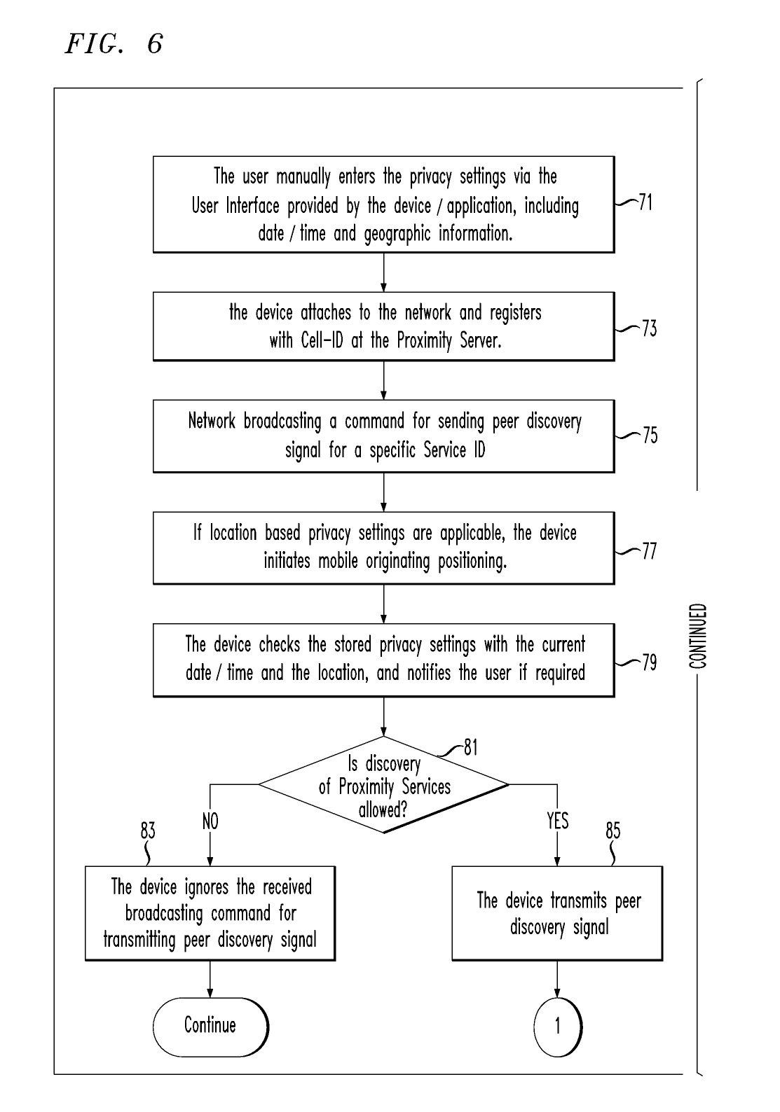

FIG. 5 depicts an exemplary process flow for proximity based services performed in a geographic area wherein a device is discoverable with peer-to-peer communications not allowed, in accordance with the principles of the present invention.

In particular, as shown in step 50 of FIG. 5 (use case 3), mobile-1 108, mobile-2 110, and mobile-3 112 all subscribe to the same proximity service (with proximity service ID-1).

As depicted in step 52, users of mobile-1 108 and mobile-3 112 do not define privacy settings, whereas the user of mobile-2 110 uses a subscriber privacy register 102 to define privacy settings as: discovery allowed and peer-to-peer (p2p) communications not allowed (or peer-to-peer (p2p) communications allowed only upon user consent). Devices that do not define privacy settings are considered discoverable, with peer-to-peer (p2p) communications allowed.

As shown in step 54, mobile-1 108, mobile-2 110, and mobile-3 112 move in to the coverage areas 114 and 116 of a base station B (BTS-B) 118 and a base station A (BTS-A) 120, respectively, and are all registered by mobile identifier and cell-ID at an inventive proximity service register 100.

As depicted in step 56, during network registration, the proximity service register 100 retrieves privacy settings defined for mobile-2 110 and forwards the privacy settings to the device 110.

In step 58, mobile-1 108 initiates a request for device (service ID-1) discovery.

As shown in step 60, in response to the discovery request, base station B (BTS-B) 118 and base station A (BTS-A) 120, both of which are located within a predefined proximity 122 of mobile-1 108, broadcast a command for peer discovery signal transmission (with service ID-1) within their respective cells 114 and 116.

As depicted in step 62, mobile-2 110 and mobile-3 112 each transmit a peer discovery signal in response to the network command.

In step 64, mobile-1 108 monitors the pilot channels of BTS-B 118 and neighbor cell, BTS-A 120, and measures the radio properties (e.g. signal strength and/or timing etc) of the peer discovery signal to determine if any mobile devices are located within a predefined proximity zone 122. Mobile-2 110 and mobile-3 112 are in proximity.

As shown in step 66, mobile-1 108 sends a peer-to-peer (p2p) communications request to mobile-2 110 and mobile-3 112.

As depicted in step 68, mobile-3 accepts the request for peer-to-peer (p2p) communications, but mobile-2 110 rejects the request, per privacy settings. Alternatively, if privacy settings defined for mobile-2 110 allow peer-to-peer (p2p) communications upon user consent, then mobile-2 110 sends a request for user consent to an end-user, upon receipt of a peer-to-peer (p2p) communications request. For exemplary purposes, mobile-2 110 does not receive user consent for peer-to-peer (p2p) communications and mobile-2 110, thus, denies the peer-to-peer (p2p) communications request.

In step 70, a peer-to-peer (p2p) communications session is established between mobile-1 108 and mobile-3 112, only.

In accordance with the principles of the present invention, as opposed to storing location based privacy settings at a network level (i.e. a network-centric solution), location based privacy settings may be stored and managed locally on a device (e.g. on a proximity based services application on a device) (i.e. a mobile-centric solution). When location based privacy settings are managed locally, a device checks its' current location (this implies that the device can trigger a positioning procedure to obtain location information) against location based privacy settings, whenever a command for peer discovery signal transmission or a request for peer-to-peer (p2p) communications is received thereon.

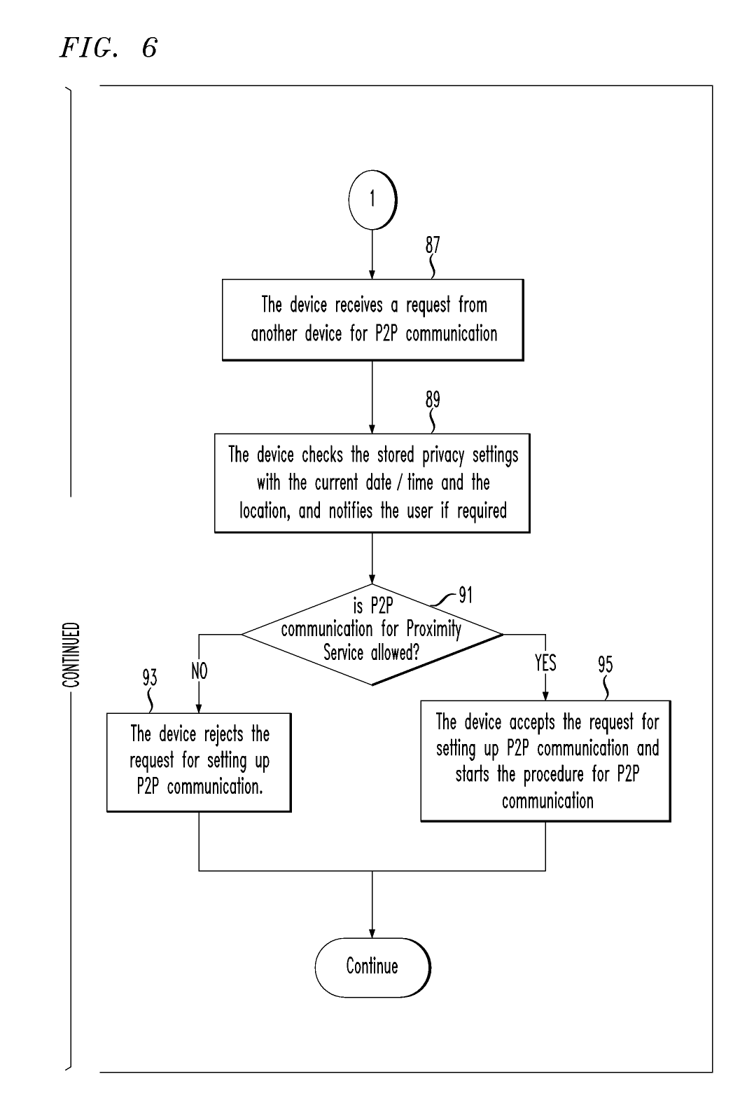

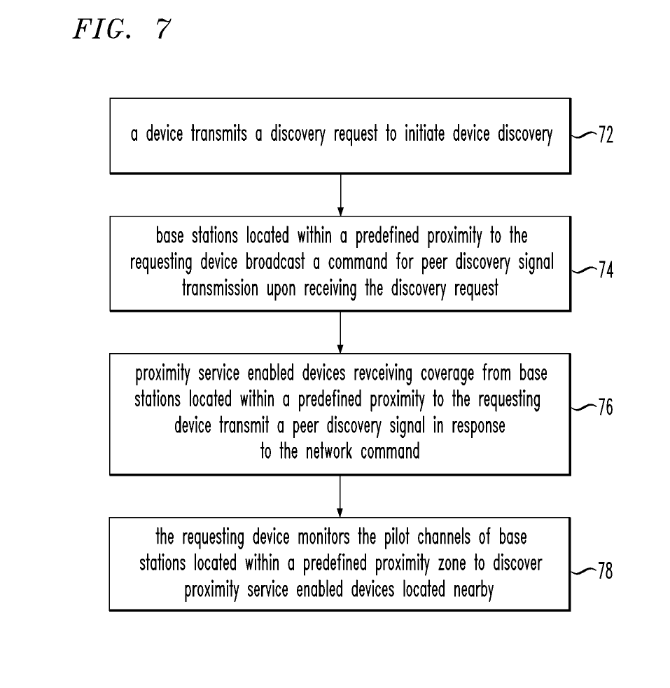

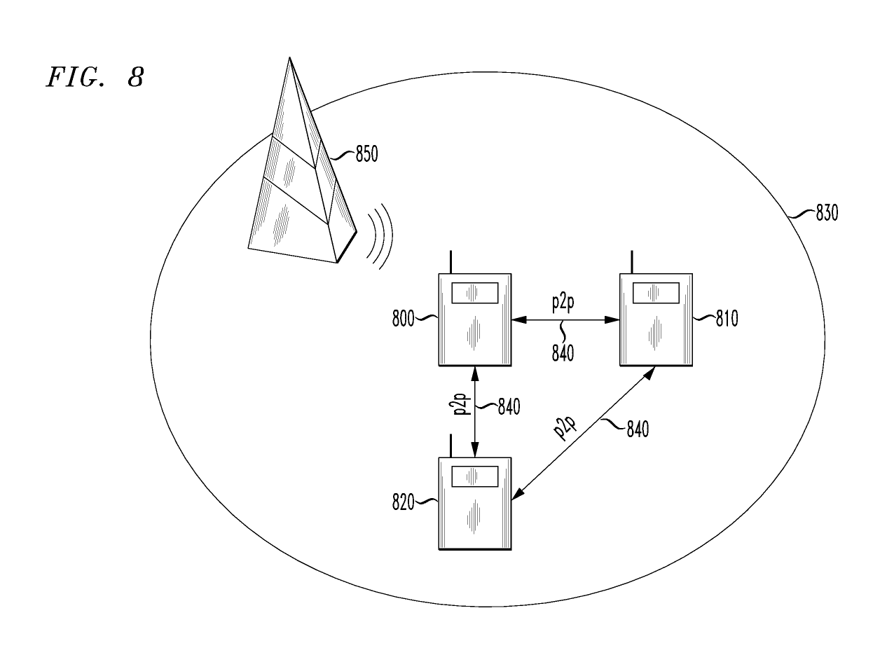

FIG. 6 depicts an exemplary mobile-centric solution for providing location based privacy for proximity based services, in accordance with the principles of the present invention.

In particular, as depicted in step 71 of FIG. 6, an end-user manually provisions preferred privacy settings for proximity based services, with relevant date/time and geographic information, via an appropriate user interface on a proximity services enabled device. In step 73, the mobile device attaches to a network and registers via cell-ID at a proximity service register. In step 75, the network broadcasts a peer discovery signal transmission command for a proximity based service (identified by service ID) to which the device is subscribed (e.g. a proximity based service with service ID-1). Upon receiving the network command, the device checks privacy settings for proximity based services, and if applicable, triggers a positioning service to retrieve current location information (step 77). As portrayed in step 79, once location information is obtained, the mobile device checks privacy settings preprovisioned thereon, against the current date/time, and against the current location, and sends a request for user consent to the end-user, if required. As portrayed in step 81, if device discovery for proximity based services is not permitted on the device (i.e. privacy settings disallow device discovery or user consent is not provided for device discovery), then the device does not transmit a peer discovery signal (step 83). Alternatively, if device discovery for proximity based services is permitted on the device (i.e. privacy settings allow device discovery and/or user consent is provided for device discovery) (step 81), then the device transmits a peer discovery signal in response to the received network command (step 85).

In step 87, the mobile device receives a peer-to-peer communications request from another subscriber device. Upon receipt, the device checks privacy settings preprovisioned thereon against the current date/time, and against a current location, and sends a request for user consent to the end-user, if required (step 89). As shown in step 91, if peer-to-peer (p2p) communications for proximity based services is not allowed on the device (i.e. privacy settings disallow peer-to-peer (p2p) communications or user consent is not provided for peer-to-peer (p2p) communications), then the device rejects the peer-to-peer (p2p) communications request received thereon (step 93). Alternatively, if peer-to-peer (p2p) communications for proximity based services is allowed on the device (i.e. privacy settings allow peer-to-peer (p2p) communications and/or user consent is provided for peer-to-peer (p2p) communications) (step 91), then the device accepts the request for peer-to-peer (p2p) communications, and a peer-to-peer (p2p) communications session is established between the mobile device and the requesting subscriber device, as portrayed in step 95.

Location based privacy for proximity based services has many potential uses.

For instance, inventive location based privacy settings may be defined so as to allow device discovery for proximity based services on a device, only when that device is located within a predefined geographic area, e.g. only when the device is located at a restaurant nearby 4^{th} Ave. in Seattle.

Moreover, location based privacy settings may be defined so as to allow both device discovery and peer-to-peer (p2p) communications for proximity based services on a device, only when that device is located within a specific geographic area. For example, if a user of a proximity services enabled device is attempting to find a Red Lobster in Downtown, Seattle, the user may define location based privacy settings so as to allow device discovery and peer-to-peer (p2p) communications for proximity based services, only when the device is located in Downtown, Seattle. This way, only when the subscribers' device is located in Downtown, Seattle, can the device receive push notifications (as a p2p communication) from a Red Lobster.

In another example, an end-user may define location based privacy settings so as to allow device discovery and peer-to-peer (p2p) communications only when a device is located in certain predefined countries (e.g., so as to avoid accumulation of international charges while travelling).

Moreover, inventive location based privacy settings may be used to restrict proximity based services for public safety devices. For instance, location based privacy settings may be defined so as to allow public safety devices to discover one another only when located within the boundaries of a specific public safety service center. If public safety devices are located outside the public safety service center (e.g., a public safety device on an officer that is off duty and at home) then the devices may not be discoverable and/or not available for peer-to-peer (p2p) communications.

The present invention is applicable to commercial location products, including user-plane and control-plane solutions.

While the invention has been described with reference to the exemplary embodiments thereof, those skilled in the art will be able to make various modifications to the described embodiments of the invention without departing from the true spirit and scope of the invention.

What is claimed is:

1. A network-centric solution for providing location based privacy for proximity based services, comprising:
a subscriber privacy register for defining a location based privacy setting for proximity based services;
a proximity service register to maintain subscriber data for said proximity based services; and
a home location server to obtain location information for said proximity services enabled device.

2. The network-centric solution for providing location based privacy for proximity based services according to claim 1, wherein:
said location based privacy setting includes a user-defined geographic area.

3. The network-centric solution for providing location based privacy for proximity based services according to claim 2, wherein:
a location based privacy restriction is assigned to said geographic area defined in said location based privacy setting.

4. The network-centric solution for providing location based privacy for proximity based services according to claim 3, wherein said location based privacy restriction is:
not discoverable.

5. The network-centric solution for providing location based privacy for proximity based services according to claim 3, wherein said location based privacy restriction is:
discovery allowed and peer-to-peer (p2p) communications not allowed.

6. The network-centric solution for providing location based privacy for proximity based services according to claim 3, wherein said location based privacy restriction is:
discovery allowed and peer-to-peer (p2p) communications allowed only upon user consent.

7. The network-centric solution for providing location based privacy for proximity based services according to claim 3, wherein said location based privacy restriction is:
discovery allowed only upon user consent and peer-to-peer (p2p) communications allowed only upon user consent.

8. The network-centric solution for providing location based privacy for proximity based services according to claim 3, wherein said location based privacy restriction is:
discovery allowed and peer-to-peer (p2p) communications allowed.

9. The network-centric solution for providing location based privacy for proximity based services according to claim 2, wherein:
said home location server converts said geographic area defined in said location based privacy setting to a corresponding network identifier.

10. The network-centric solution for providing location based privacy for proximity based services according to claim 1, wherein:
said location based privacy setting is stored and managed at a network level.

11. The network-centric solution for providing location based privacy for proximity based services according to claim 1, wherein:
said location based privacy setting is stored in a subscriber privacy database on said subscriber privacy register.

12. The network-centric solution for providing location based privacy for proximity based services according to claim 1, wherein:
said proximity service register forwards said location based privacy setting to said proximity services enabled device during a network registration.

13. The network-centric solution for providing location based privacy for proximity based services according to claim 1, wherein:
said proximity services enabled device checks a current data and time and a serving network identifier against said location based privacy setting to determine if proximity based services are allowed on said proximity services enabled device.

14. A mobile-centric solution for providing location based privacy for proximity based services, comprising:
defining a location based privacy setting on a proximity services enabled device;
triggering a mobile-originated positioning procedure to obtain current location information; and
enabling proximity based services on said proximity services enabled device, based on a match of current date and time, and said current location information, against said location based privacy setting.

15. The mobile-centric solution for providing location based privacy for proximity based services according to claim 14, wherein:
said location based privacy setting is defined via a user interface on said proximity services enabled device.

16. The mobile-centric solution for providing location based privacy for proximity based services according to claim 14, wherein:
said location based privacy setting is managed locally on said proximity services enabled device.

17. The mobile-centric solution for providing location based privacy for proximity based services according to claim 14, wherein:
said location based privacy setting includes a user-defined geographic area.

18. The mobile-centric solution for providing location based privacy for proximity based services according to claim 17, wherein:
a location based privacy restriction is assigned to said geographic area defined in said location based privacy setting.

19. The mobile-centric solution for providing location based privacy for proximity based services according to claim 18, wherein said location based privacy restriction is:
not discoverable.

20. The mobile-centric solution for providing location based privacy for proximity based services according to claim 18, wherein said location based privacy restriction is:
discovery allowed and peer-to-peer (p2p) communications not allowed.

21. The mobile-centric solution for providing location based privacy for proximity based services according to claim 18, wherein said location based privacy restriction is:
discovery allowed and peer-to-peer (p2p) communications allowed only upon user consent.

22. The mobile-centric solution for providing location based privacy for proximity based services according to claim 18, wherein said location based privacy restriction is:
discovery allowed only upon user consent and peer-to-peer (p2p) communications allowed only upon user consent.

23. The mobile-centric solution for providing location based privacy for proximity based services according to claim 18, wherein said location based privacy restriction is:
discovery allowed and peer-to-peer (p2p) communications allowed.

24. A method for providing a network-centric location based privacy solution for proximity based services, comprising:
defining a location based privacy setting for a proximity services enabled device at a subscriber privacy register;
registering with a proximity service register via cell ID and service ID;
forwarding said location based privacy setting defined for said proximity services enabled device to said proximity services enabled device during network registration; and
enabling proximity based services on said proximity services enabled device, based on a match of current date and time, and said current location information, against said location based privacy setting.

25. The method for providing a network-centric location based privacy solution for proximity based services according to claim 24, wherein:
said location based privacy setting defined for said proximity services enabled device includes a geographic area.

26. The method for providing a network-centric location based privacy solution for proximity based services according to claim 25, wherein:
a location based privacy restriction is assigned to said geographic area defined in said location based privacy setting.

27. The method for providing a network-centric location based privacy solution for proximity based services according to claim 26, wherein said location based privacy restriction is:
not discoverable.

28. The method for providing a network-centric location based privacy solution for proximity based services according to claim 26, wherein said location based privacy restriction is:
discovery allowed and peer-to-peer (p2p) communications not allowed.

29. The method for providing a network-centric location based privacy solution for proximity based services according to claim 26, wherein said location based privacy restriction is:
discovery allowed and peer-to-peer (p2p) communications allowed only upon user consent.

30. The method for providing a network-centric location based privacy solution for proximity based services according to claim 26, wherein said location based privacy restriction is:
discovery allowed only upon user consent and peer-to-peer (p2p) communications allowed only upon user consent.

31. The method for providing a network-centric location based privacy solution for proximity based services according to claim 26, wherein said location based privacy restriction is:
discovery allowed and peer-to-peer (p2p) communications allowed.

32. The method for providing a network-centric location based privacy solution for proximity based services according to claim 24, wherein:
said location based privacy setting forwarded to said proximity services enabled device includes a network identifier converted from said geographic area defined in said location based privacy setting.

33. The method for providing a network-centric location based privacy solution for proximity based services according to claim 32, wherein:
said geographic area is converted to a network identifier by a home location server.

34. The method for providing a network-centric location based privacy solution for proximity based services according to claim 24, wherein:
said location based privacy setting is stored and managed at a network level.

35. The method for providing a network-centric location based privacy solution for proximity based services according to claim 24, wherein:
said location based privacy setting is stored in a subscriber privacy database on said subscriber privacy register.

36. The method for providing a network-centric location based privacy solution for proximity based services according to claim 24, wherein:
said proximity service register forwards said location based privacy setting to said proximity services enabled device during network registration.
